(19) United States
(12) Patent Application Publication
(10) Pub. No.: US 2008/0298255 A1
(43) Pub. Date: Dec. 4, 2008

(54) Communication terminal

(75) Inventor: Tosaku Tanada, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Kabushiki Kaisha Toshiba, Tokyo (JP)

(21) Appl. No.: 12/005,487

(22) Filed: Dec. 27, 2007

(30) Foreign Application Priority Data
May 28, 2007 (JP) P2007-140840

(51) Int. Cl. H04J 3/14

(52) U.S. Cl. 370/242

(57) ABSTRACT

According to an aspect of the invention, there is provided a communication terminal including: an interrupt factor detecting unit configured to detect an interrupt factor causing data transmission interrupt if data transmission is performed with an external terminal; and a transmission unit configured to transmit a response added with an error code corresponding to the interrupt factor to the external terminal in response to a request transmitted from the external terminal if the interrupt factor detecting unit detects the interrupt factor during data transmission between the external terminal serving as a client and the communication terminal serving as a server.

### CROSS-REFERENCE TO RELATED APPLICATIONS

This application is based on and claims the benefit of priority from the prior Japanese Patent Application No. 2007-140840, filed on May 28, 2007; the entire contents of which are incorporated herein by reference.

### TECHNICAL FIELD

The present invention relates to a communication terminal, and particularly to the communication terminal capable of performing data transmission using a data communication protocol such as Bluetooth (registered trademark).

### BACKGROUND

Recently, as a wireless communication technique applicable to electronic apparatuses and the like, for example, Bluetooth (registered trademark) has been known. When the wireless communication technique of such Bluetooth is used, audio data can be transmitted from a portable information terminal such as a cellular phone or a portable audio player to other apparatuses such as a headset without an audio cable. In addition, exchange of a business card or the like can be performed just by transmitting and receiving data between portable information terminals such as a cellular phone (see JP-A-2006-119847).

When data such as a file are exchanged between the portable information terminals, data transmission is performed based on a data communication protocol of a request/response type such as an object exchange protocol (OBEX). Such OBEX is a protocol in which data transmission is performed by a repeated operation in which a client transmits a request and a sever receiving the request returns a response corresponding to the request to the client.

Since OBEX has a specification in which a server transmits a request to a client, the server cannot request the client to interrupt data transmission. Accordingly, in a-known example, in order for the server to interrupt the data transmission, it is necessary to cut the link between layers, such as connection of a short-distance communication, lower than OBEX.

However, when the link between the lower layers is cut to interrupt the data transmission from the server, a problem arises in that when the client wishes to transmit another data after the link interruption, the link between the lower layers has to be connected again, and time and work is necessary until the re-connection. Moreover, the link between the lower layers is cut to interrupt the data transmission from the server, the link is abruptly cut in the client, thereby resulting failure in data transmission. Accordingly, since the client cannot know the failure factor in the data transmission, it is difficult for the client to determine whether to retry data transmission.

### SUMMARY

According to an aspect of the invention, there is provided a communication terminal including: an interrupt factor detecting unit configured to detect an interrupt factor causing data transmission interrupt when data transmission is performed with an external terminal; and a transmission unit configured to transmit a response added with an error code corresponding to the interrupt factor to the external terminal in response to a request transmitted from the external terminal when the interrupt factor detecting unit detects the interrupt factor during data transmission between the external terminal serving as a client and the communication terminal serving as a server.

According to another aspect of the invention, there is provided a communication terminal including: a communication control unit; and a wireless short-distance communication unit configured to notify the communication control unit that the wireless short-distance communication receives a transmission request from an external terminal if the transmission request is received from an external terminal. If the communication control unit is notified that the wireless short-distance communication unit is received the transmission request, the communication control unit instructs the wireless short-distance communication unit to interrupt the data transmission if an interrupt factor causing interrupt of the data transmission is detected until a notification of the reception request, and the communication control unit performs the data transmission if the interrupt factor is not detected until the notification of the reception request.

According to still another aspect of the invention, there is provided a communication terminal including: a wireless short-distance communication unit; and a communication control unit. The wireless short-distance communication unit notifies the communication control unit that the wireless short-distance communication unit receives a reception request if the reception request is received from an external terminal. If the communication control unit is notified that the wireless short-distance communication unit has received the reception request, the communication control unit instructs the wireless short-distance communication unit to interrupt the data reception if an interrupt factor causing interrupt of data transmission is detected until a notification of the reception request, and the communication control unit allows the received data to be stored if the interrupt factor is not detected until the notification of the reception request.

### BRIEF DESCRIPTION OF THE DRAWINGS

In the accompanying drawings:

FIG. 1 is an exemplary diagram illustrating an overall configuration of a system transmitting and receiving information;

FIG. 2 is an exemplary block diagram illustrating a configuration of the communication terminals;

FIG. 3 is an exemplary flowchart for explaining an operation of data transmission in a communication terminal shown in FIG. 2;

FIG. 4 is an exemplary diagram illustrating a sequence of a specific operation between the communication terminal as the server and the communication terminal as the client when the data transmission operation described with reference to the flowchart in FIG. 3 is performed;

FIG. 5 is an exemplary diagram illustrating a data structure of an OBEX packet generated in the operation of the data transmission;

FIG. 6 is an exemplary diagram for explaining an interrupt factor generated in the communication terminal during the data transmission;

FIG. 7 is an exemplary flowchart for explaining another operation of data transmission in the communication terminal shown in FIG. 2; and

FIG. 8 is an exemplary diagram illustrating a sequence of a specific operation between the communication terminal as the server and the communication terminal as the client when performing the operation of the data transmission described with reference to the flowchart in FIG. 7.

### DESCRIPTION OF THE EMBODIMENTS

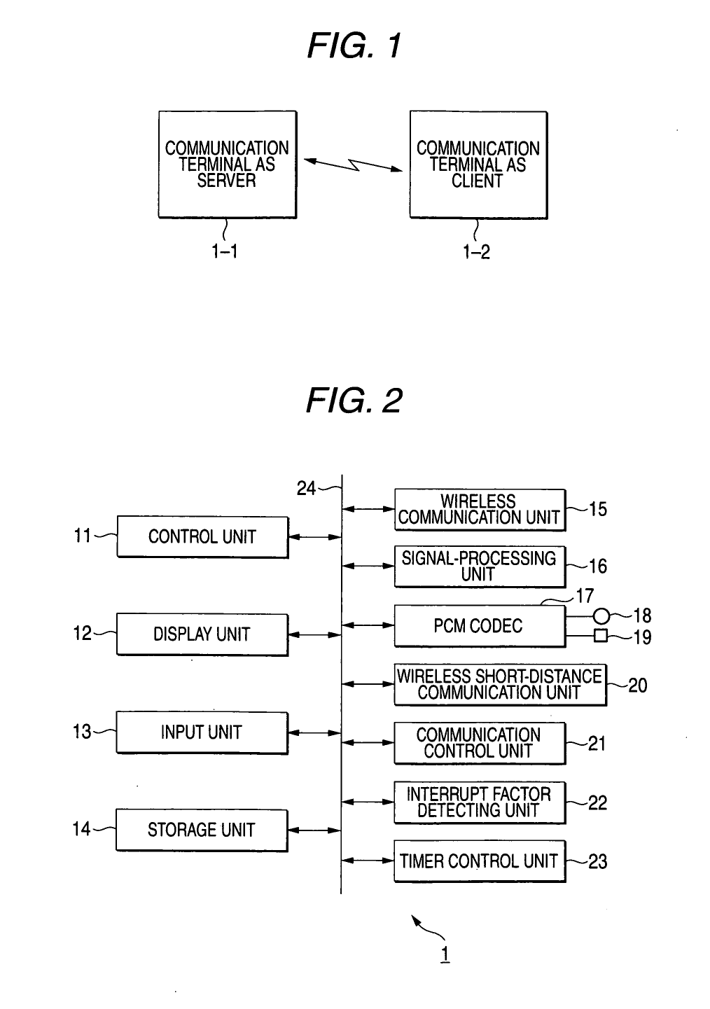

Hereinafter, an embodiment of the invention will be described with reference to the drawings. According to the embodiment, FIG. 1 illustrates an overall configuration of a system transmitting and receiving information. A client communication terminal 1-2 is located close to a server communication terminal 1-1. The server communication terminal 1-1 and the client communication terminal 1-2 perform data communication by wireless communication (for example, Bluetooth), using a data communication protocol of a request/response type such as an object exchange protocol (OBEX). Both the terminals can exchange files such as a card. For example, as such terminals, a cellular phone can be used, but the invention is not limited thereto.

FIG. 2 is a diagram illustrating a configuration of the communication terminals 1 shown in FIG. 1. As shown in FIG. 2, each of the communication terminals 1 includes a control unit 11, a display unit 12, an input unit 13, a storage unit 14, a wireless communication unit 15, a signal processing unit 16, a PCM codec 17, a microphone 18, a speaker 19, a wireless short-distance communication unit 20, a communication control unit 21, an interrupt factor detecting unit 22, and a timer control unit 23 are connected to each other through a bus 24.

The control unit 11 includes a central processing unit (CPU), a read-only memory (ROM), and a random access memory (RAM). The CPU performs various operations according to a program stored in the ROM or various application programs loaded from the storage unit 14 to the RAM and generally the communication terminals 1 by generating various control signals and supplying them to each unit. The RAM stores appropriately stores necessary data after the CPU performs various operations.

The display unit 12 is constituted by a liquid crystal display (LCD) or the like and the input unit 13 is formed of operation keys (not shown), operation buttons, etc.

The wireless communication unit 15 receives wireless signals transmitted from a base station (not shown) through an antenna (not shown) and performs a down-converter process of the received wireless signals to produce intermediate frequency signals. The wireless communication unit also performs an orthogonal demodulation process, a reverse diffusion of each pass by an RAKE receiver (not shown), and synthesis process. Afterward, the received packet data output from the RAKE receiver is input to the signal processing unit 16.

The signal processing unit 16, which is constituted by, for example, a digital signal processor (DSP), first separates the received packet data according to media classes and performs a decoding process of the separated data of each media class.

For example, when the received packet data contain audio data, the signal processing unit 16 decodes the audio data by a speech codec. In addition, when the received packet data contain picture image data, the signal processing unit 16 decodes the video data by a video codec. In addition, when the received packet data contain download content, the signal processing unit 16 decompresses the download content.

The digital audio signals obtained by the decoding process is decoded by the PCM codec 17, amplified, and output through the speaker 19. On the other hand, the digital video signals decoded by the video codec are supplied to the display unit 12 through the bus 24 to be displayed.

The wireless short-distance communication unit 20, which is constituted by a module for performing wireless communication based on Bluetooth (registered trademark), performs wireless between communication the communication terminal 1 (for example, the communication terminal 1-1 in FIG. 1) and another communication terminal 1 (for example, the communication terminal 1-2) which are located close to each other. Of course, wireless communication (for example, an infrared-ray communication) other than Bluetooth may be used.

The communication control unit 21 generally controls communication performed with another communication terminal 1 through the wireless short-distance communication unit 20. For example, using an OBEX profile, the communication control unit generally controls communication of the wireless short-distance communication unit 20 according to various profiles.

The interrupt factor detecting unit 22 detects whether any interrupt factor (for example, operation or call reception of a user) is present during data transmission performed through the wireless short-distance communication unit 20 with another communication terminal 1. The timer control unit 23 controls a timer mounted in the communication terminal 1.

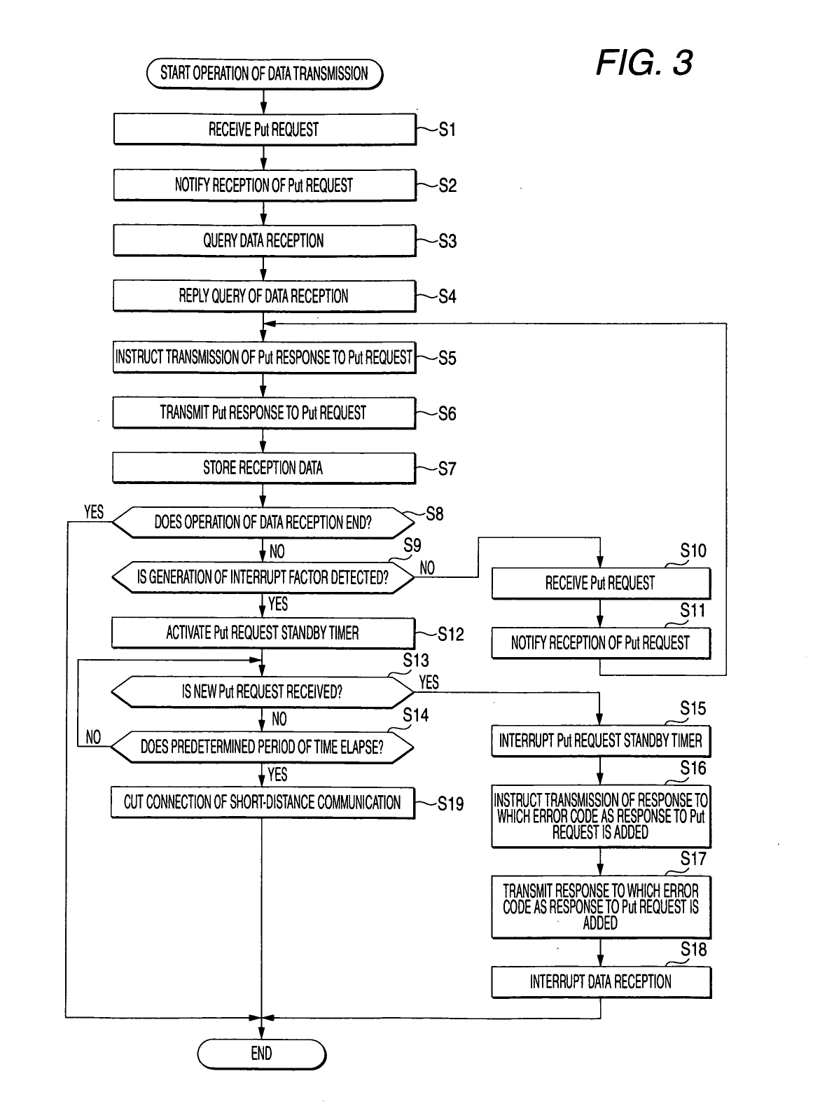

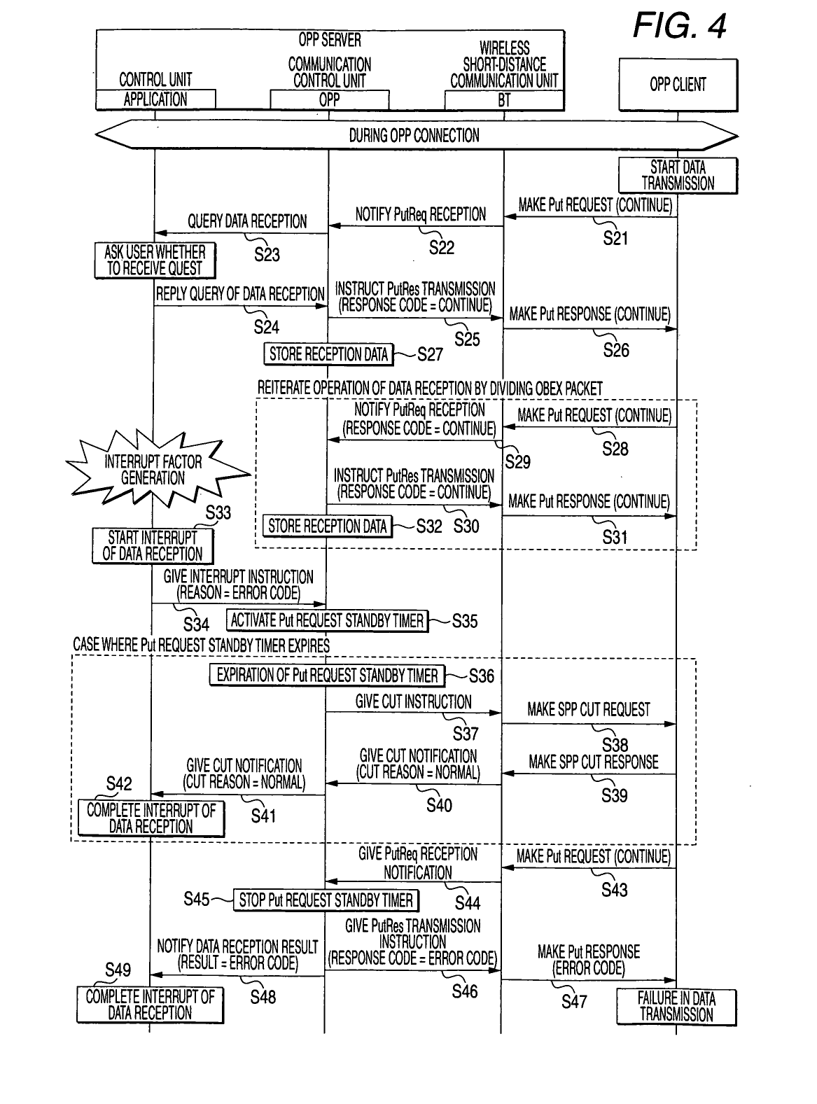

Next, with reference to a flowchart shown in FIG. 3, a data transmission operation when the communication terminal 1 shown in FIG. 2 serves as a server will be described. The data transmission operation is performed when data transmission is started from the communication terminal 1 (for example, the communication terminal 1-2 in FIG. 1) as a client to the communication terminal 1 (for example, the communication terminal 1-1 in FIG. 1) as a sever. In particular, in a case in FIG. 3, an object push profile (OPP) enables connection between the communication terminal as the server and the communication terminal as the client. At this time, when the data such as a business card is transmitted and received on the basis of the OPP is started, an operation in the server when the data is transmitted from the communication terminal 1 as the client to the communication terminal 1 as the server will be described. In addition, FIG. 4 is a diagram illustrating a specific operation sequence between the communication terminal 1 as the server and the communication terminal 1 as the client when the data transmission operation described with reference to the flowchart in FIG. 3 is performed.

In step S1, a wireless short-distance communication unit 20 of the communication terminal 1 as the server receives a Put request which is a request for transmitting data from the communication terminal 1 as the client (step S21 in FIG. 4) from the communication terminal 1 as the client. The Put request contains an object representing actual data such as a file.

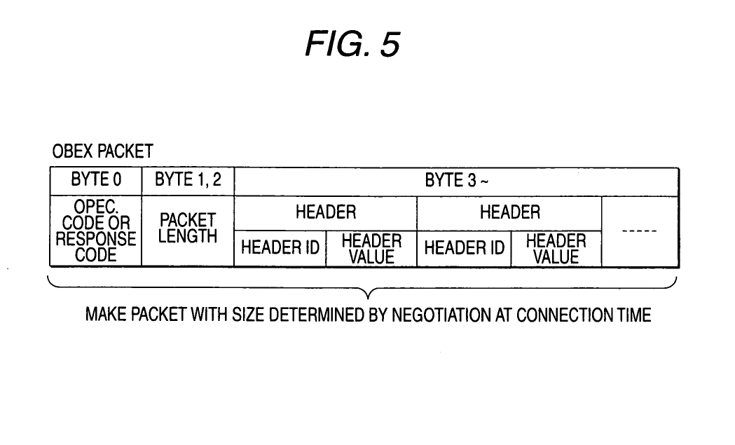

For example, like the Put request, an OBEX packet which is used upon performing the data transmission according to an OBEX protocol and has a predetermined size has a data structure such as shown in FIG. 5. The OBEX packet is generated so as to have a predetermined packet-length determined at connection time by negotiation with communication terminal 1 as the client. In addition, an operation code or a response code, a packet length, and a header are added to the OBEX packet.

In step S2, when the wireless short-distance communication unit 20 receives the Put request, which is the request for transmitting data from the communication terminal 1 as the client, it supplies the communication control unit 21 with a Put request reception notification (PutReq reception notification) for notifying the reception of the Put request (step S22 in FIG. 4).

In step S3, when it acquires the Put request reception notification from the wireless short-distance communication unit 20, the communication control unit 21 queries data reception of an upper application program controlled by the control unit 11 or the like (step S23 in FIG. 4). When the data reception of the upper application program controlled by the control unit 11 or the like is queried, the control unit 11 executes the upper application program and queries to a user through the display unit 12 whether the user receives the Put request from the communication terminal as the client or not (whether to receive the Put request) (for example, display of “A data transmission request from OO is received. Is the request accepted?”).

In step S4, when an instruction to receive the Put request by operating the input unit 14 by the user and is received, the control unit 11 executes the upper application program and makes a data query response to the communication control unit 21 (step S24 in FIG. 4).

In step S5, when it acquires the data query response from the control unit 11, the communication control unit 21 controls the wireless short-distance communication unit 20 to performs a Put request transmission instruction (response code=continue) to instruct transmission of a Put response to the Put request from the communication terminal 1 as the client (step S25 in FIG. 4).

In step S6, when it acquires the Put request transmission instruction (response code=continue) from the communication control unit 21, the wireless short-distance communication unit 20 transmits the Put response (continue) (response to the Put request from the client) to instruct the communication terminal 1 as the client to transmit a new Put request to the communication terminal 1 as the client through wireless communication (step S26 in FIG. 4). In step S7, the object as the actual data contained in the Put request transmitted from the communication terminal 1 as the client is stored in the storage unit 14 (step S27 in FIG. 4).

In step S8, the communication control unit 21 determines whether the data reception operation between the communication terminal as the server and the communication terminal 1 as the client ends. When the data reception operation between the communication terminal as the server and the communication terminal 1 as the client is completed in step S8, the data transmission operation is completed. Alternatively, when the data reception with the communication terminal 1 as the client does not end in step S8, the interrupt factor detecting unit 22 detects whether any interrupt factor to interrupt the data transmission with the communication terminal 1 as the client through the wireless short-distance communication unit 20 is generated.

When it detects the generation of any interrupt factor to interrupt the data transmission with the communication terminal 1 as the client through the wireless short-distance communication unit 20, as shown in step S33 or S34 in FIG. 4, the control unit 11 executes the upper application program, interrupts the data transmission (the data reception in FIGS. 3 and 4), and supplies an interrupt instruction (reason=error code) of the data transmission to the communication control unit 21. Subsequently, in step S9, the communication control unit 21 determines whether to detect the generation of any interrupt factor to interrupt the data transmission with the communication terminal 1 as the client through the wireless short-distance communication unit 20 by determining whether to acquire the interrupt instruction of the data transmission supplied from the control unit 11.

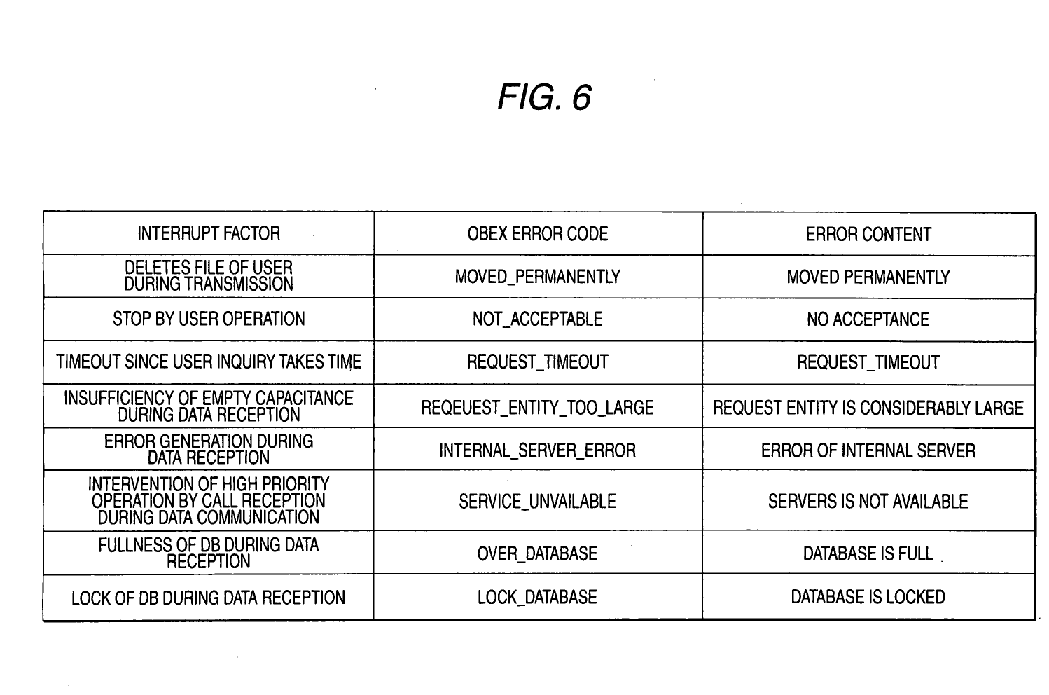

As any interrupt factor to interrupt the data transmission, interrupt factors shown in FIG. 6 can be exemplified. As shown in FIG. 6, examples of the interrupt factor include “a case where a user instructs file deletion during the data transmission”, “a case where a user interrupts the data transmission”, “a case where the response cannot be transmitted to the external terminal within the predetermined period of time”, “a case where an amount of space is insufficient during the data transmission”, “a case where error is generated in the storage unit during the data transmission”, “a case where a high priority operation (for example, operation of call reception) is intervened during the data transmission”, “a case where the empty number of items is insufficient during the data transmission”, and “a case where the storage unit 14 (database) is locked during the data transmission”.

In step S9, when it is determined that any interrupt factor to interrupt the data transmission is not detected during the data transmission with the communication terminal 1 as the client through the wireless short-distance communication unit 20, the process proceeds to step S10, the Put request in steps S10 and S11 is received, and the reception of the Put request is notified. Afterward, the process proceeds to the step S5 to reiterate the subsequent processes of step S5.

In step S9, when it is determined that any interrupt factor is generated during the data transmission with the communication terminal 1 as the client through the wireless short-distance communication unit 20, the communication control unit 21 notifies the fact that any interrupt factor to interrupt the data transmission is generated to the timer control unit 23 in step S12 and also activates a Put request standby timer, which is a timer to wait the Put request of the communication terminal 1 as the client for a predetermined period of time (for example, 2 or 3 seconds). The timer control unit 23 activates the Put request standby timer using a mounted timer according to the control of the communication control unit 21 to set the preset Put request standby timer to a predetermined period of time (step S35 in FIG. 4).

In step S13, the communication control unit 21 determines whether to receive the new Put request from the communication terminal 1 as the client through the wireless short-distance communication unit 20 or not. When it is determined that the new Put request is not received from the communication terminal 1 as the client in step S13, the communication control unit 21 controls the timer control unit 23, starts to clock the Put request standby timer, and determines whether the predetermined period of time elapses in step S14.

When it is determined that the predetermined period of time does not elapsed after the Put request standby timer is clocked in step S14, the process returns to step S13 to determine whether to receive a new Put request in step S13. In this way, using the Put request standby timer, it is possible to wait reception of the Put request from the communication terminal 1 as the client until the predetermined period of time elapses.

Alternatively, when it is determined that the new Put request is received from the communication terminal 1 as the client in step S13, the communication control unit 21 controls the timer control unit 23 in step S15 and stops the Put request standby timer (step S45 in FIG. 4). In step S16, the communication control unit 21 allows the wireless short-distance communication unit 20 to perform transmission instruction (Put request transmission instruction (response code=error code)) of response to which an error code corresponding to the interrupt factor generated in the communication terminal 1 as the server is added as a response to the new Put request transmitted from the communication terminal 1 as the client (step S46 in FIG. 4).

In step S17, when it acquires the Put request transmission instruction (response code=error code) from the communication control unit 21, the wireless short-distance communication unit 20 transmits the Put response (response to the Put request from the client) added with the error code as response to the Put request to the communication terminal 1 as the client through wireless communication (step S47 in FIG. 4). As shown in FIG. 6, for example, in “as the case where the user instructs the file deletion during the data transmission”, a “MOVED_PERMANENTLY” as the error code corresponding to the interrupt factor is added to the Put response. The same is applied to other interrupt factors.

The communication terminal 1 as the client receives the Put response (error code) transmitted from the communication terminal 1 as the server and the data transmission operation fails.

At this time, the communication control unit 21 gives notification (result=error code) of data reception result to the upper application program controlled by the control unit 11 (step S48 in FIG. 4).

In step S18, when it acquires the notification of the data reception result from the communication control unit 21, the control unit 11 executes the upper application program and interrupts the operation of the data transmission (data reception) with the communication terminal 1 as the client (step S49 in FIG. 4). At this time, however, even when the operation of the data transmission (data reception) with the communication terminal 1 as the client is interrupted, the connection (link) with the communication terminal 1 as the client is maintained without cutting the connection (link) with the communication terminal 1 as the client in a lower layer.

Alternatively, when it is determined that the predetermined period of time elapses after starting to clock the Put request standby timer in step S14, the communication control unit 21 controls the wireless short-distance communication unit 20 in step S19 and cuts the connection of the lower layer. That is, as shown in step S36 or S42 in FIG. 4, the communication control unit 21 gives a cut instruction to instruct the wireless short-distance communication unit 20 to cut the lower layer, and transmits a request for cutting a serial port profile (SPP) to the communication terminal 1 as the client through the wireless short-distance communication unit 20. The wireless short-distance communication unit 20 supplies the cut notification to the communication control unit 21 when receiving an SPP cutting response from the communication terminal 1 as the client. According to the cutting notification from the wireless short-distance communication unit 20, the communication control unit 21 gives the cutting notification for the upper application program controlled by the control unit. The control unit 21 executes the upper application program and completes the interrupt of the data transmission (data reception) with the communication terminal 1 as the client.

In this way, in a case where no Put request is made from the communication terminal 1 as the client after generation of the interrupt factor and the predetermined period of time elapses after starting the Put request standby timer, the link of the lower layer is immediately cut and the data transmission (data reception) with the communication terminal 1 as the client can be interrupted.

In the embodiment of the invention, data is divided into several packets with a predetermined size and repeatedly transmitted using a request/response type data communication protocol. At this time, when the interrupt factor to cause interrupt of the data transmission is detected, the Put response to which the error code corresponding to the interrupt factor generated in the communication terminal 1 as the server is added is transmitted in response to the Put request transmitted from the communication terminal 1 as the client, and the data transmission with the communication terminal 1 as the client can be interrupted.

In this way, the OBEX enables the communication terminal 1 as the server to appropriately interrupt the transmission with the communication terminal 1 as the client an arbitrary timing accompanied with the interrupt factor. Moreover, the link of the lower layer at the interrupt time is not cut. Accordingly, when another data is transmitted from the communication terminal 1 as the client after the interrupt, it is not necessary to re-connect the link between both the communication terminals without additional time and effort until the re-connection. In addition, since the communication terminal 1 as the client can receive the error code suitable (determined by a known OBEX protocol) for the interrupt factor from the communication terminal 1 as the server at the interrupt time, the client can know failure cause of the data transmission. Accordingly, it is possible to easily determine whether to re-try the data transmission.

When the interrupt factor is generated in the server during the data transmission using the data communication protocol of the request/response type, the data transmission operation can be appropriately interrupted. As a result, it is possible to improve convenience when the data transmission is performed on the basis of the request/response type data communication protocol.

In the operation of the data transmission described with reference to FIGS. 3 and 4, the case where the data (object) is transmitted from the communication terminal 1 as the client to the communication terminal 1 as the server has been described. However, the embodiment may be applied to a case where the communication terminal 1 as the client requests the communication terminal 1 as the server to transmit data (object) and the communication terminal 1 as the server transmits the data (object) to the communication terminal 1 as the client. Hereinafter, an operation of the data transmission using such a method will be described.

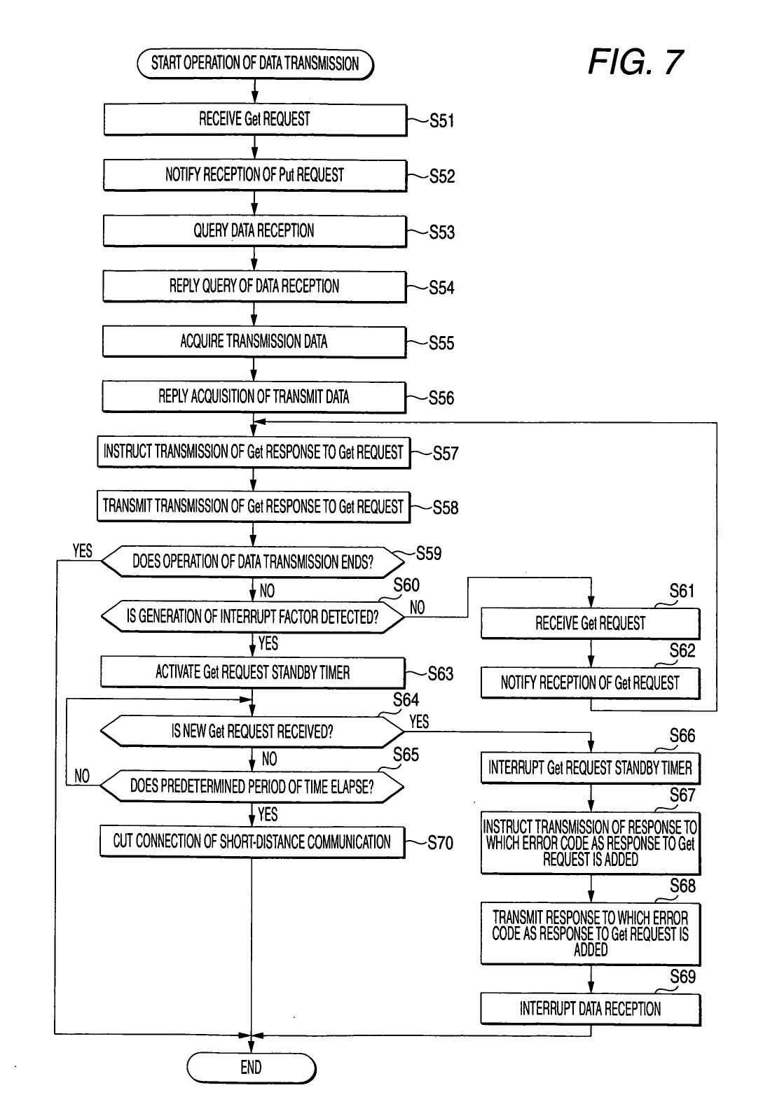

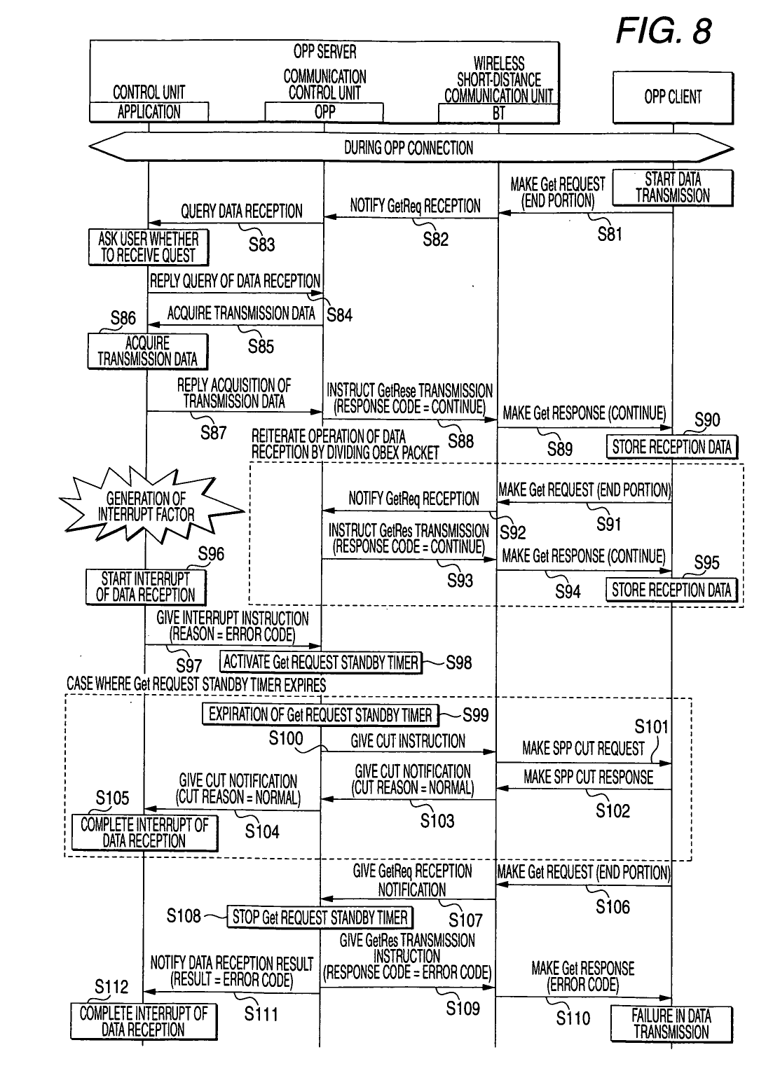

With reference to a flowchart in FIG. 7, another operation of data transmission to the communication terminal 1 as the server in FIG. 2 will be described. Such an operation of the data transmission is executed when the data transmission starts from the communication terminal 1 (for example, the communication terminal 1-2 in FIG. 1) as the client to the communication terminal 1 (for example, the communication terminal 1-1 in FIG. 1). In particular, in FIG. 7, the object push profile (OPP) enables connection between the communication terminal as the server and the communication terminal as the client, and thus the operation of the data transmission and reception such as a business card by the OPP starts. A case where the data is transmitted from the communication terminal 1 as the server to the communication terminal 1 as the client will be described. In addition, FIG. 8 is a diagram illustrating a sequence of a specific operation between the communication terminal 1 as the server and the communication terminal 1 as the client when performing the operation of the data transmission described with reference to the flowchart in FIG. 7.

Operations from steps S51 to S69 in FIG. 7 are the same as those from steps S1 to S19 in FIG. 3 and the repeated same description will be appropriately omitted.

In steps S51 to S58, the wireless short-distance communication unit 20 of the communication terminal 1 as the server receives from the communication terminal 1 as the client a Get request for asking the communication terminal 1 as the server to perform the data transmission by the communication terminal 1 as the client (step S81 in FIG. 8). Information to request the transmission of the actual data such as a file is stored in a header of the Get request.

Afterward, when it receives the Get request for asking the transmission of the data from the communication terminal 1 as the client, the wireless short-distance communication unit 20 supplies the communication control unit 21 with a Get request reception notification (GetReq reception notification) to notify that the Get request is received (step S82 in FIG. 8). When it acquires the Get request reception notification from the wireless short-distance communication unit 20, the communication control unit 21 performs a data reception query for an upper application program controlled by the control unit 11 or the like (step S83 in FIG. 8). When the data reception query for the upper application program controlled by the control unit 11 or the like is performed, the control unit 11 performs the upper application program and asks a user whether to receive the Get request from the communication terminal as the client or not (whether the Get request is received or not) through the display unit 12.

The control unit 11 executes the upper application program and makes response to the data query to the communication control unit 21 (step S84 in FIG. 8), and the communication control unit 21 instructs the upper application program to acquire transmission data for the communication terminal 1 as the client in step S55 (step S85 in FIG. 8). The control unit 11 executes the upper application program in accordance with the instruction to acquire the transmission data from the communication control unit 21, acquires the transmission data stored in the storage unit 14 from the storage unit 14, and supplies a transmission data acquisition response representing transmission data acquisition to the communication control unit 21 (steps S86 and S87 in FIG. 8).

When it acquires the transmission data acquisition response from the control unit 11, the communication control unit 21 instructs the wireless short-distance communication unit 20 to transmit the Get request (response code=continue) for instructing the Get response for the Get request from the communication terminal 1 as the client (step S88 in FIG. 8).

When it acquires the Get request transmission instruct (response code=continue) from the communication control unit 21, the wireless short-distance communication unit 20 transmits the Get response (continue) (response for the Get request from the client) for instructing the communication terminal 1 as the client to transmit a new Get request to the communication terminal 1 as the client through wireless communication (step S89 in FIG. 8). In addition, the Get response contains actual data such as file. As shown in step S90 in FIG. 8, an object as the actual data contained in the received Get response is stored as the received data in the communication terminal 1 as the client.

Afterward, in step S59, the communication control unit 21 determines whether the operation of the data transmission with the communication terminal 1 as the client ends. When it is determined that the operation of the data transmission with the communication terminal 1 as the client does not end in step S59, the interrupt factor detecting unit 22 repeatedly detects that any interrupt factor is generated during the data transmission with the communication terminal 1 as the client through the wireless short-distance communication unit 20.

In step S60, when it is determined that generation of any interrupt factor to interrupt the data transmission is detected during the data transmission with the communication terminal 1 as the client through the wireless short-distance communication unit 20, the communication control unit 21 notifies the timer control unit 23 that the generation of any interrupt factor to interrupt the data transmission is detected in step S62, and activates the Get request standby timer which is a timer to wait the Get request from the communication terminal 1 as the client for a predetermined period of time (for example, 2 or 3 seconds) (step S98 in FIG. 8).

In step S63, when it is determined that the new Get request is received from the communication terminal 1 as the client, the communication control unit 21 controls the timer-control-unit 23 in step S65 and stops the Get request standby timer (step S108 in FIG. 8). In step S66, the communication control unit 21 gives, as the response to the new Get request transmitted from the communication terminal 1 as the client, a transmission instruction (Get request transmission instruction (response code=error code)) of the response to which the error code corresponding to the interrupt factor generated in the communication terminal 1 as the server to the wireless short-distance communication unit 20 (step S109 in FIG. 8).

In step S67, when it acquires the Get request transmission instruction (response code=error code) from the communication control unit 21, the wireless short-distance communication unit 20 transmits a Get response (response to the Get request from the client) to which the error code as the response to the Get request is added to the communication terminal 1 as the client through wireless communication (step S110 in FIG. 8).

The communication terminal 1 as the client receives the Get response (error code) transmitted from the communication terminal 1 as the server. In addition, the operation of the data reception fails.

At this time, the communication control unit 21 gives the notification (result=error code) of the data transmission result to the upper application program controlled by the control unit 11 (step S111 in FIG. 8).

In step S68, when it acquires the notification of the data transmission result from the communication control unit 21, the control unit 11 executes the upper application program and stops the operation of the data transmission (data reception) with the communication terminal 1 as the client (step S112 in FIG. 8). At this time, however, even when the operation of the data transmission (data reception) with the communication terminal 1 as the client is interrupted, the connection (link) with the communication terminal 1 as the client is not cut and the connection (link) of the lower layer is maintained.

Alternatively, when it is determined that the predetermined period of time elapses after start of the Get-request standby timer in step S64, the communication control unit 21 controls the wireless short-distance communication unit 20 in step S69 and cuts the connection of the lower layer. Such an operation is the same as that in step S19 in FIG. 3 and the repeated description is omitted.

In this way, data is divided into several packets with a predetermined size and repeatedly transmitted using the request/response type data communication protocol. At this time, when the interrupt factor to cause interrupt of the data transmission is detected, the Get response to which the error code corresponding to the interrupt factor generated in the communication terminal 1 as the server is added is transmitted in response to the Get request transmitted from the communication terminal 1 as the client, and the data transmission with server and the communication terminal 1 as the client can be interrupted.

Accordingly, even when the data (object) is transmitted from the communication terminal 1 as the server to the communication terminal 1 as the client, the OBEX enables the communication terminal 1 as the server to appropriately interrupt the transmission with the communication terminal 1 as the client an arbitrary timing accompanied with the interrupt factor. Moreover, the link of the lower layer at the interrupt time is not cut. Accordingly, when another data is transmitted from the communication terminal 1 as the client after the interrupt, it is not necessary to re-connect the link between both the communication terminals without additional time and effort until the re-connection. In addition, since the communication terminal 1 as the client can receive the error code suitable for the interrupt factor from the communication terminal 1 as the server at the interrupt time, the client can know failure cause of the data transmission. Accordingly, it is possible to easily determine—whether to re-try the data transmission.

When the interrupt factor is generated in the server during the data transmission using the request/response type data communication protocol, the data transmission operation can be appropriately interrupted. As a result, it is possible to improve convenience when the data transmission is performed on the basis of the request/response type data communication protocol.

The embodiment may be applied to, for example, a personal digital assistant (PDA), a personal computer, a portable game equipment, a portable music player, a portable video player as the communication terminal 1.

The series of operations described in the embodiment can be executed by software, but may be executed by a hardware apparatus.

In the embodiment, the steps of the flowchart are executed in a time-oriented manner according to the described sequence. However, even when the steps may be not necessarily executed in the time-oriented manner, the steps may be executed in parallel or individually.

According to the above-described embodiment, a communication terminal can perform appropriate data transmission interruption when an interruption factor is caused in a server during the data transmission performed by using a data communication protocol of a request/response type.

What is claimed is:

1. A communication terminal comprising:
an interrupt factor detecting unit configured to detect an interrupt factor causing data transmission interrupt if data transmission is performed with an external terminal; and
a transmission unit configured to transmit a response added with an error code corresponding to the interrupt factor to the external terminal in response to a request transmitted from the external terminal if the interrupt factor detecting unit detects the interrupt factor during data transmission between the external terminal serving as a client and the communication terminal serving as a server.

2. The communication terminal according to claim 1, comprising:
a determination unit configured to determine whether a predetermined period of time elapses after generation of the interrupt factor,
wherein the transmission unit transmits the response added with the error code corresponding to the interrupt factor to the external terminal in response to the request of the external terminal until the determination unit determines that the predetermined period of time is elapsed after the generation of the interrupt factor.

3. The communication terminal according to claim 1, comprising:
a data transmission interrupt control unit configured to cut a short-distance communication with the external terminal if the determination unit determines that the predetermined period of time is elapsed after the generation of the interrupt factor.

4. The communication terminal according to claim 3, wherein the data transmission interrupt control unit interrupts the data transmission with the external terminal after the transmission unit transmits the response added with the error code corresponding to the interrupt factor to the external terminal.

5. The communication terminal according to claim 1, wherein the interrupt factor is a case where file deletion is instructed during the data transmission.

6. The communication terminal according to claim 1, wherein the interrupt factor is a case where interrupt of the data transmission is instructed.

7. The communication terminal according to claim 1, wherein the interrupt factor is a case where the response cannot be transmitted to the external terminal within the predetermined period of time.

8. The communication terminal according to claim 1, wherein the interrupt factor is a case where an amount of space is insufficient during the data transmission.

9. The communication terminal according to claim 1, wherein the interrupt factor is a case where an error is generated in a storage unit during the data transmission.

10. The communication terminal according to claim 1, wherein the interrupt factor is a case where a high priority operation is intervened during the data transmission.

11. The communication terminal according to claim 1, wherein the interrupt factor is a case where an empty number of items is insufficient during the data transmission.

12. The communication terminal according to claim 1, wherein the interrupt factor is a case where a storage unit is locked during the data transmission.

13. A communication terminal comprising:
a communication control unit; and
a wireless short-distance communication unit configured to notify the communication control unit that the wireless short-distance communication receives a transmission request from an external terminal if the transmission request is received from an external terminal,
wherein, if the communication control unit is notified that the wireless short-distance communication unit is received the transmission request, the communication control unit instructs the wireless short-distance communication unit to interrupt the data transmission if an interrupt factor causing interrupt of the data transmission is detected until a notification of the reception request, and the communication control unit performs the data transmission if the interrupt factor is not detected until the notification of the reception request.

14. A communication terminal comprising:
a wireless short-distance communication unit; and
a communication control unit,
wherein the wireless short-distance communication unit notifies the communication control unit that the wireless short-distance communication unit receives a reception request when the reception request is received from an external terminal; and
wherein, if the communication control unit is notified that the wireless short-distance communication unit has received the reception request, the communication control unit instructs the wireless short-distance communication unit to interrupt the data reception if an interrupt factor causing interrupt of data transmission is detected until a notification of the reception request, and the communication control unit allows the received data to be stored if the interrupt factor is not detected until the notification of the reception request.
